(19) United States
(12) Patent Application Publication
(10) Pub. No.: US 2025/0330259 A1
(43) Pub. Date: Oct. 23, 2025

(54) RADIO DEVICE AND METHOD IN A WIRELESS COMMUNICATIONS NETWORK

(71) Applicant: Telefonaktiebolaget LM Ericsson (publ), Stockholm (SE)

(72) Inventors: Lars ERNSTROM, Mountain View, CA (US); Jonathan LYNAM, San Jose, CA (US); Seungtai KIM, Solna (SE); Henning WIEMANN, Aachen (DE); Göran RUNE, Linköping (SE); Harald GUSTAFSSON, Lund (SE)

(21) Appl. No.: 18/870,135

(22) PCT Filed: Jun. 3, 2022
(86) PCT No.: PCT/SE2022/050550

§ 371 Date: Nov. 27, 2024

(51) Int. Cl. H04L 1/00; H04W 28/02

(52) U.S. Cl. CPC H04L 1/0003; H04L 1/0061; H04W 28/0268

(57) ABSTRACT

A method performed by a radio device for handling data transmissions in a wireless communications network. The radio device determines (202) one or more first transmission parameters for a first part of an application data unit to be transmitted. The first part of the application data unit is associated with a first latency requirement. The radio device determines one or more second transmission parameters for one or more second parts of the application data unit to be transmitted. The one or more second parts of the application data unit is associated with a second latency requirement. The second latency requirement is related to a shorter latency than the first latency requirement. The radio device transmits (203) the application data unit using the first transmission parameters for transmitting the first part of the application data unit and the second transmission parameters for transmitting the second parts of the application data unit.

### TECHNICAL FIELD

Embodiments herein relate to a radio device and method therein. In some aspects, they relate to handling transmissions in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

Consider delay sensitive application traffic where the delay sensitivity is expressed per unit of application payload, so that data within the same unit have the same timing requirement, e.g., the same deadline. Assume that the size of units generally is large enough to occupy many radio channel transport blocks. For example, for a video transport application, a unit consisting of a compressed video frame often needs many, e.g., 100, Internet Protocol (IP) packets. For transporting data over a radio channel, a radio base station decides on an encoding with a certain level of robustness based on the channel quality and the application traffic requirements. For example, for Mobile Broadband (MBB) traffic an encoding with Block Error Rate (BLER) target of 10% is desired. For Ultra Reliable Low Latency Communication (URLLC) traffic a much more robust encoding is used.

### SUMMARY

As part of developing embodiments herein a problem was identified by the inventor and will first be discussed.

For delay sensitive application traffic, retransmission of a later part of an application data unit will affect the delay more than retransmission an earlier part. Therefore, current encoding and/or retransmission schemes that are unaware of the application layer data unit boundaries, are not optimal in terms of minimizing the delay.

An object of embodiments herein is to improve the performance of a wireless communications network by a more flexible encoding and/or retransmission scheme in the wireless communications network.

According to an aspect of embodiments herein, the object is achieved by a method performed by a radio device for handling data transmissions in the wireless communications network.

The radio device determines one or more first transmission parameters for a first part of an application data unit to be transmitted and one or more second transmission parameters for one or more second parts of the application data unit to be transmitted. The first part of the application data unit is associated with a first latency requirement and the one or more second parts of the application data unit is associated with a second latency requirement. The second latency requirement is related to a shorter latency than the first latency requirement.

The radio device transmits the application data unit using the one or more first transmission parameters for transmitting the first part of the application data unit and the one or more second transmission parameters for transmitting the one or more second parts of the application data unit.

According to another aspect of embodiments herein, the object is achieved by a radio device configured to handle data transmissions in a wireless communications network. The radio device is further configured to:
Determine one or more first transmission parameters for a first part of an application data unit to be transmitted, wherein the first part of the application data unit is adapted to be associated with a first latency requirement and determine one or more second transmission parameters for one or more second parts of the application data unit to be transmitted, wherein the one or more second parts of the application data unit is adapted to be associated with a second latency requirement, which second latency requirement is adapted to be related to a shorter latency than the first latency requirement, and
transmit the application data unit using the one or more first transmission parameters for transmitting the first part of the application data unit and the one or more second transmission parameters for transmitting the one or more second parts of the application data unit.

Thanks to that the radio device determines the one or more first transmission parameters and the one or more second transmission parameter, it is possible for the radio device to transmit the first part and the one or more second parts of the application data unit using different transmission parameters. In this way an efficient mechanism for handling transmissions is achieved.

Embodiments herein brings the advantage of an efficient mechanism improving the performance in the wireless communications network. This is achieved by a more flexible encoding and/or retransmission scheme in wireless communications network, where the radio device determines, at least partly, different transmission parameters for a first part and one or more second parts of an application data unit to be transmitted. This leads to a more flexible handling of transmissions, and results in an improved performance in the wireless communications network.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIG. 2 is a flowchart depicting embodiments of a method in a radio device.

FIGS. 3a and b are schematic block diagrams illustrating embodiments of a radio device.

FIG. 4 schematically illustrates a telecommunication network connected via an intermediate network to a host computer.

FIG. 5 is a generalized block diagram of a host computer communicating via a base station with a user equipment over a partially wireless connection.

FIGS. 6 to 9 are flowcharts illustrating methods implemented in a communication system including a host computer, a base station and a user equipment.

### DETAILED DESCRIPTION

Embodiments herein relate to a wireless communications network and the handling of transmissions in the wireless communications network.

As mentioned above, the object of embodiments herein is to improve the performance of a wireless communications network by a more flexible encoding and/or retransmission scheme in the wireless communications network.

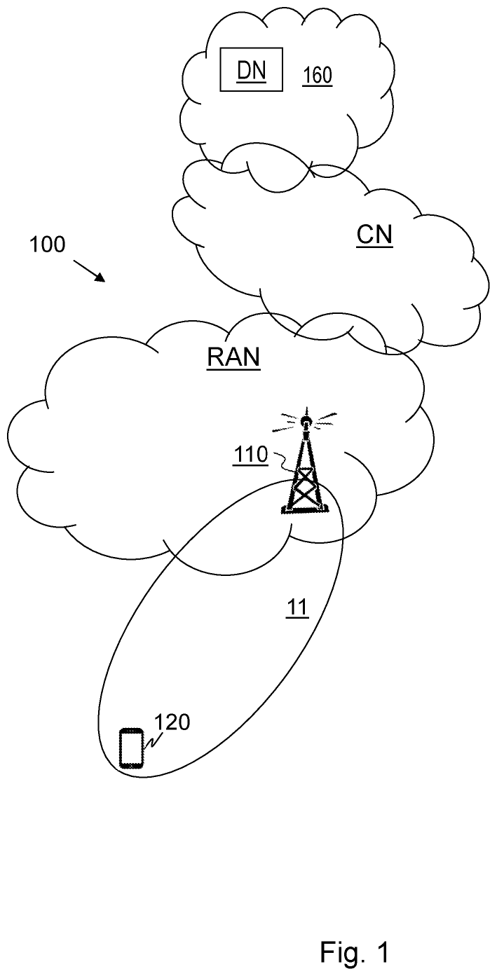

FIG. 1 is a schematic overview depicting a communications network 100 wherein embodiments herein may be implemented. The communications network 100 comprises one or more RANs and one or more CNs. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

One or more UEs operate in the communication network 100, such as e.g. the radio device 120. The radio device may also be referred to as the UE 120. The radio device 120 may e.g. be 5G-RG, a UE, a remote UE, a wireless device, an NR device, a mobile station, a wireless terminal, an NB-IoT device, an MTC device, an eMTC device, a CAT-M device, a WiFi device, an LTE device and an a non-access point (non-AP) STA, a STA, that communicates via a base station such as e.g. a network node 110, one or more Access Networks (AN), e.g. a RAN, to one or more core network (CN) nodes, in one or more CNs. The radio device 120 may communicate with one or more CN nodes by a fixed network connection, such as e.g. cable and/or optical fiber. It should be understood by the skilled in the art that “UE” is a non-limiting term which means any terminal, client, mobile client, IMS client, wireless communication terminal, user equipment, Device to Device (D2D) terminal, or node e.g. smart phone, laptop, mobile phone, sensor, relay, mobile tablets or even a car or any small base station communicating within a cell.

Base stations such as the radio device 110, operate in the wireless communications network 100. The radio device 110 may also be referred to as the radio network node 110. The radio device 110 provides one or more cells such as a first cell 11. The radio device 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs, such as the radio device 120, within the first cell 11, served by the radio device 110. The radio device 110 may be referred to as a serving radio network node and communicates with the radio device 120 with Downlink (DL) transmissions to the radio device 120 and Uplink (UL) transmissions from the radio device 120.

Methods according to embodiments herein are performed by the radio device 110, 120. This node may be a Distributed Node (DN) and functionality, e.g. comprised in a cloud 160 as shown in FIG. 1 may be used for performing or partly performing the methods.

Embodiments herein e.g., provide a method for handling transmissions in the wireless communications network 100.

Examples of embodiments herein may e.g., bring the advantage latency aware radio channel coding. This may be achieved by using a more efficient and/or flexible encoding and/or retransmission scheme. By determining transmission parameters, e.g., related to encoding and/or retransmission, separately for different parts of an application data unit to be transmitted, transmission of the application data unit may be performed to meet requirement related to the transmission.

A number of embodiments will now be described, some of which may be seen as alternatives, while some may be used in combination.

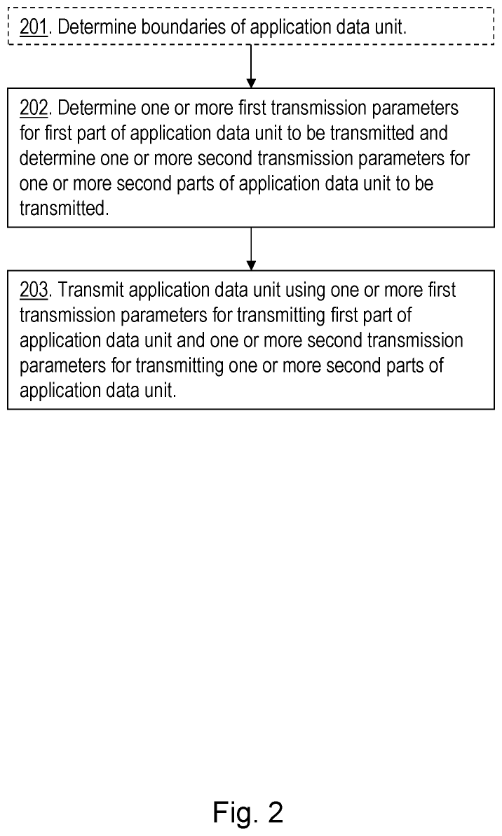

A method according to embodiments will now be described from the view of the radio device 110 together with FIG. 2. FIG. 2 depicts example embodiment of a method performed by the radio device 110, 120 for handling data transmissions in a wireless communications network 100. The radio device 110, 120 may be any one out of: the radio network node 110, or the UE 120.

The method comprises the following actions, which actions may be taken in any suitable order. Actions that are optional are presented in dashed boxes in FIG. 2.

### Action 201

In some embodiments, the radio device 110, 120 determines boundaries of an application data unit to be transmitted. The boundaries comprise the start and the end of the application data unit. An application data unit when used herein, may mean data that has the same timing requirement. This may mean that the data in the application data unit have the same delivery deadline. Determining the boundaries of the application data unit may further comprise receiving the application data unit, e.g., from a higher layer in the radio device 110, 120.

### Action 202

The radio device 110, 120 determines one or more first transmission parameters for the first part of the application data unit to be transmitted. The first part of the application data unit is associated with a first latency requirement. The radio device 110, 120 further determines one or more second transmission parameters for one or more second parts of the application data unit to be transmitted. The one or more second parts of the application data unit is associated with a second latency requirement. The second latency requirement is related to a shorter latency than the first latency requirement. This means that the transmission parameters for transmitting the first part of the application data unit may be different compared to the transmission parameters for transmitting one or more second parts of the application data unit. The first and second latency requirements are related to transmission latency requirement. The latency may be related to the latency of the transmission of the application data unit. The second latency requirements may be one or more second latency requirements. The one or more second latency requirements may be identical, or at least one of the one or more second latency requirements may be different from the other of the one or more second latency requirements. Accordingly, the one or more second part of the application data units may be associated to a respective second latency requirement. This may mean that at least one of the one or more second parts of the application data units is associated with a second latency requirement that is different from the second latency requirement associated to the other of the one or more second parts of the application data units. In some examples the second latency requirement is different for all of the one or more second parts of the application data units. In some examples a second latency requirement associated with a second part of the application data unit is related to shorter latency than the second latency requirement associated to a preceding second part of the application data unit.

The one or more transmission parameters for transmitting a part of the application data unit that associated with a latency requirement related to a shorter latency may be more robust transmission parameters than the one or more transmission parameters for transmitting a part of the application data unit that associated with a latency requirement related to a longer latency. More robust may mean e.g., a lower code rate, a lower order of modulation, a shorter delay between retransmissions, a lower number of retransmission attempts, a higher number Control Channel Elements (CCE) resources, a higher level of aggregation, a higher transmit power.

A transmission parameter may be any one or more out of: A modulation and coding scheme (MCS), a retransmission policy, a resource allocation, a control channel assignment policy, a scheduling policy, a transmit power, and a number of Multiple-Input Multiple-Output, MIMO, layers. A retransmission policy may e.g., be any one or more out of: Hybrid Automatic Repeat Request (HARQ), the maximum number of retransmission attempts, and the delay between retransmissions. A resource allocation may e.g., be a number of resource blocks to be allocated. A control channel assignment policy may e.g., be related to a number of CCEs and/or an aggregation level. A scheduling policy may e.g., mean that the transmission is scheduled to minimize the number of transmissions.

An MCS may e.g., be Orthogonal Frequency Division Multiplexing (OFDM) with a variety of specific modulation types: Binary Phase Shift Keying (BPSK), Quadrature Phase Shift Keying (QPSK), 16-state Quadrature Amplitude Modulation (16QAM), 64-state QAM (64QAM), etc. Examples of coding schemes are Low-density parity-check codes (LDPC codes), Turbo codes, Polar codes. For each of these codes there are parameters that control the code rate. Different code rates may be used for transmitting the different parts of the application data unit.

A value of at least one of the one more first parameters may be different from the value of a corresponding parameter of the one or more second transmission parameters. As an example, a parameter of the one of the one or more first parameters may be the maximum number of HARQ retransmission attempts, and its value may e.g., be three. This means that a corresponding parameter of the one or more second parameters, the number of HARQ retransmission attempts, may have another value, e.g., two.

In some embodiments, the radio device 110, 120 determines the one or more first transmission parameters and the one or more second transmission parameters by further determining the first part and the one or more second parts of the application data unit. The radio device 110, 120 determines the first part and the one or more second parts of the application data unit taking the determined boundaries into account.

In some embodiments, the one or more second transmission parameters may be determined individually for at least one of the one or more second parts of the application data unit. This may mean that at least one of the one or more second parts of the application data unit will be transmitted using one or more second transmission parameters that are different compared to the one or more second transmission parameters of the other of the one or more second parts of the application data unit. In other words, the one or more second transmission parameters for transmitting a second part of the application data unit may different from the one or more transmission parameters for transmitting another second part of the application data unit.

In some embodiments, the one or more first transmission parameters and the one or more second transmission parameters are determined to maximize a success rate for the transmission of the application data unit. Maximizing a success rate may mean that the success rate of the transmission is above a first threshold, such as e.g., that the percentage of the application data unit that is received with a latency that is within, e.g., shorter of equal to, the latency requirement, such as the first and/or second latency requirement, of the application data unit is above the first threshold.

In some embodiments, the one or more first transmission parameters and the one or more second transmission parameters are determined to minimize the amount of radio resources used for the transmission of the application data unit.

In some embodiments, the one or more first transmission parameters and the one or more second transmission parameters are determined to minimize a transmission delay for the transmission of the application data unit. Minimizing the transmission delay may e.g., mean that the transmission delay of the transmission is below a third threshold.

In some embodiments, the one or more first transmission parameters and the one or more second transmission parameters are determined to minimize an error rate for the transmission of the application data unit. Minimizing the error rate may e.g., mean that the error rate of the transmission is below a fourth threshold. The error rate may e.g., be related to a BLER target.

In some embodiments, the radio device 110, 120 determines the first part and the one or more second parts of the application data unit to any one or more out of: Maximize the success rate for the transmission of the application data unit, minimize the amount of radio resources used for the transmission of the application data unit, minimize the transmission delay for the transmission of the application data unit, and minimize the error rate for the transmission of the application data unit.

In some embodiments, determining the one or more first transmission parameters and the one or more second transmission parameters further comprises that the radio device 110, 120 determines a requirement related to the transmission of the application data unit. The requirement may e.g., be any one or more out of: A timing requirement, such as a deadline when the application data unit should be received by the recipient, a BLER target, a delay of the transmission, a latency of the transmission and an amount radio resources to be used for the transmission, or a combination of some of the listed requirements. The requirement may e.g., be determined by a type of application associated to the application data unit, a Quality of Service (QOS) associated to the application data unit and or a Quality of Experience (QoE) associated to the application data unit. Application requirements may be needed to provide quality of experience for Virtual and/or Augmented reality or to enable manual or autonomous remote control of vehicles or machinery.

In some embodiments, the radio device 110, 120 determines the one or more first transmission parameters and the one or more second transmission parameters based on the requirement. Alternatively, or additionally, the radio device 110, 120 determines the first part and the one or more second parts of the application data unit based on the requirement.

### Action 203

The radio device 110, 120 transmits the application data unit using the one or more first transmission parameters for transmitting the first part of the application data unit and the one or more second transmission parameters for transmitting the one or more second parts of the application data unit. Transmitting the application data unit may comprise dividing the application data unit according to the size of transmission units, e.g., transport blocks, Physical Resource Blocks (PRB), radio frames, subframes, slots, symbols. A part of the application data unit, such as the first part and the one or more second parts of the application data unit, may comprise one or more transmission units. The transmission parameters used for transmitting a specific part of the application data unit may be applied to the one or more transmission units comprised in the specific part of the application data unit.

In some embodiments, the first part of the application unit is transmitted before the one or more second parts of the application data unit.

Embodiments mentioned above will now be further described and exemplified. The embodiments below is applicable to and may be combined with any suitable embodiment described above.

With knowledge about the boundaries of delay sensitive application units, such as the application data unit, it may be possible to use a more efficient modulation, encoding and/or retransmission scheme, e.g., the one or more first transmission parameters. This may be done by using more opportunistic schemes for encoding and/or retransmission for an earlier part of the application unit of payload, such as the first part of the application data unit, when there is time for retransmissions and more robust schemes for encoding and/or retransmission for a later part of the application unit payload, such as the one or more second parts of the application data unit, when there is not enough time for retransmission. The following coding parameters may be set with variable values for different parts of the transmission of the application data unit:
MCS
Number of, e.g., HARQ, retransmission attempts
Delay between, e.g., HARQ, retransmissions

For a given fixed amount of resources for a radio channel, a unit of data, e.g., the application data unit, and a time deadline, an encoding/retransmission scheme, such as the one or more first transmission parameters and the one or more second transmission parameters, may be chosen, such as e.g., determined, so that the success-rate for the transmission of the application data unit is maximized.

The following schemes may also be possible:
Given a unit of data, such as the application data unit, with a time deadline and a unit error rate, such as an error rate target, minimize the amount of radio resources used for transmitting the application data unit.
Given a unit of data, such as the application data unit, a unit error rate, such as an error rate target, an amount of radio resources, e.g., an amount of available radio resources, minimize the application data unit transmission delay.
Given a unit of data, such as the application data unit, with time deadline, application unit resources, an amount of radio resources, e.g., an amount of available radio resources, minimize the error rate.
Maximize the size of data units, such as the application data unit, that may be transmitted with given time deadline, a unit error rate, such as an error rate target, and an amount of radio resources, e.g., an amount of available radio resources.

Payload unit, such as the application data unit, e.g., a video frame, boundaries may either be indicated in packets, or discovered by analysis of traffic patterns, e.g., by applying Artificial Intelligence (AI) and/or Machine Learning (ML) techniques, or by simple protocol dependent rules. An example discovery rule, for Real Time Protocol (RTP) protocols all packets having identical timestamp belong to the same frame and/or buffer. An example packet indication utilize the Differential Service field marking initial packets of a frame as to indicate maximize throughput, and the later parts as to indicate minimize delay.

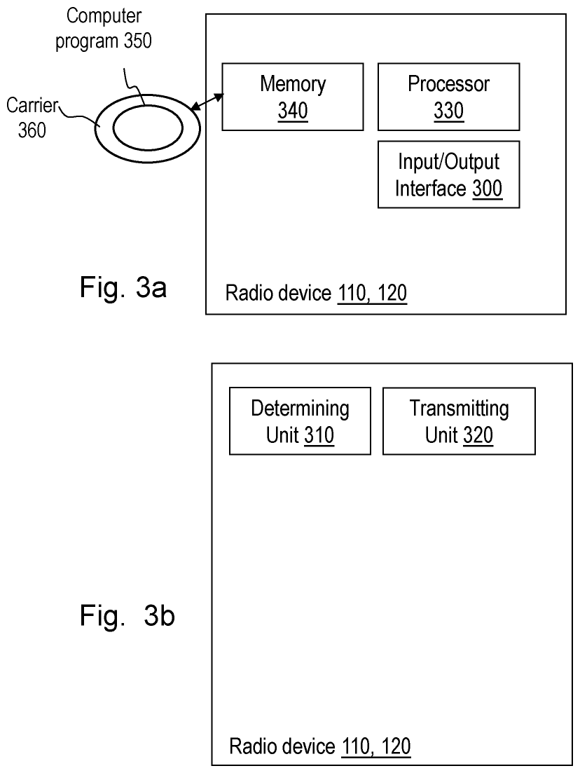

To perform the method actions, the radio device 110, 120 may comprise an arrangement depicted in FIG. 3a and b. The radio device 110, 120 configured to handle data transmissions in the wireless communications network 100.

The radio device 110, 120 may be adapted to be any one out of: A radio network node 110, or UE 120.

The radio device 110, 120 may comprise an input and output interface 300 configured to communicate with e.g. the UE 120, the radio network node 110, and other nodes operating in the wireless communications network 100

The radio device 110, 120 is further configured to, e.g. by means of a determining unit 310 in the radio device 110, 120, determine one or more first transmission parameters for the first part of the application data unit to be transmitted, wherein the first part of the application data unit is adapted to be associated with a first latency requirement, and determine one or more second transmission parameters for one or more second parts of the application data unit to be transmitted, wherein the one or more second parts of the application data unit is adapted to be associated with a second latency requirement, which second latency requirement is adapted to be related to a shorter latency than the first latency requirement.

The radio device 110, 120 may further be configured to, e.g. by means of the determining unit 310 in the radio device 110, 120, determine boundaries of the application data unit to be transmitted. The boundaries are adapted to comprise the start and the end of the application data unit.

The radio device 110, 120 may be configured to determine the one or more first transmission parameters and the one or more second transmission parameters by further being configured to determine the first part and the one or more second parts of the application data unit, taking the determined boundaries into account.

A value of at least one of the one more first parameters may be adapted to be different from the value of a corresponding parameter of the one or more second transmission parameters.

A transmission parameter may be adapted to be any one or more out of: An MCS, retransmission policy, a resource allocation, a control channel assignment policy, a scheduling policy, a transmit power, and a number of MIMO layers.

The one or more first transmission parameters and one or more second transmission parameters may be adapted to be determined to maximize a success rate for the transmission of the application data unit.

The one or more first transmission parameters and one or more second transmission parameters may be adapted to be determined to minimize that amount of radio resources used for the transmission of the application data unit.

The one or more first transmission parameters and one or more second transmission parameters may be adapted to be determined to minimize a transmission delay of the transmission of the application data unit.

The one or more first transmission parameters and one or more second transmission parameters may be adapted to be determined to minimize an error rate for the transmission of the application data unit.

The radio device 110, 120 is further configured to, e.g. by means of a transmitting unit 320 in the radio device 110, 120, transmit the application data unit using the one or more first transmission parameters for transmitting the first part of the application data unit and the one or more second transmission parameters for transmitting the one or more second parts of the application data unit.

The first part of the application data unit may adapted to be transmitted before the one or more second parts of the application data unit.

The embodiments herein may be implemented through a respective processor or one or more processors, such as the processor 330 of a processing circuitry in the radio device 110, 120 depicted in FIG. 3a, together with respective computer program code for performing the functions and actions of the embodiments herein. The program code mentioned above may also be provided as a computer program product, for instance in the form of a data carrier carrying computer program code for performing the embodiments herein when being loaded into the radio device 110, 120. One such carrier may be in the form of a CD ROM disc. It is however feasible with other data carriers such as a memory stick. The computer program code may furthermore be provided as pure program code on a server and downloaded to the radio device 110, 120.

The radio device 110, 120 may further comprise a memory 340 comprising one or more memory units. The memory comprises instructions executable by the processor 330 in the radio device 110, 120. The memory 340 is arranged to be used to store e.g. information, messages, application data units, transmission parameters, communication data and applications and applications to perform the methods herein when being executed in the radio device 110, 120.

In some embodiments, a computer program 350 comprises instructions, which when executed by the respective at least one processor 330, cause the at least one processor 330 of the radio device 110, 120 to perform the actions above.

In some embodiments, a respective carrier 360 comprises the respective computer program 350, wherein the carrier 360 is one of an electronic signal, an optical signal, an electromagnetic signal, a magnetic signal, an electric signal, a radio signal, a microwave signal, or a computer-readable storage medium.

Those skilled in the art will appreciate that the units in the radio device 110, 120 described above may refer to a combination of analog and digital circuits, and/or one or more processors configured with software and/or firmware, e.g. stored in the radio device 110, 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### Further Extensions and Variations

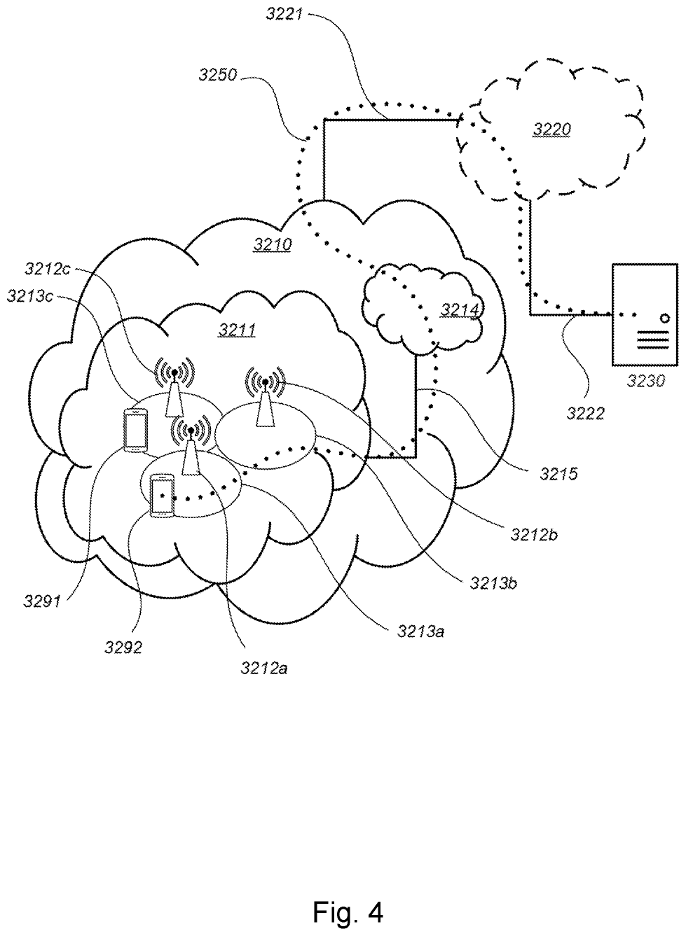

With reference to FIG. 4, in accordance with an embodiment, a communication system includes a telecommunication network 3210, such as a 3GPP-type cellular network, which comprises an access network 3211, such as a radio access network, and a core network 3214. The core network 3214 may e.g. comprise the network node 150, the first IMS node 110, the one or more second IMS nodes 131, 132, 133 and the subscriber data node 140. The access network 3211 comprises a plurality of base stations 3212a, 3212b, 3212c, e.g. the base station 105, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the UE 121 and/or a Non-AP STA 3291 located in coverage area 3213c is configured to wirelessly connect to, or be paged by, the corresponding base station 3212c. A second UE 3292 such as another UE 121 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

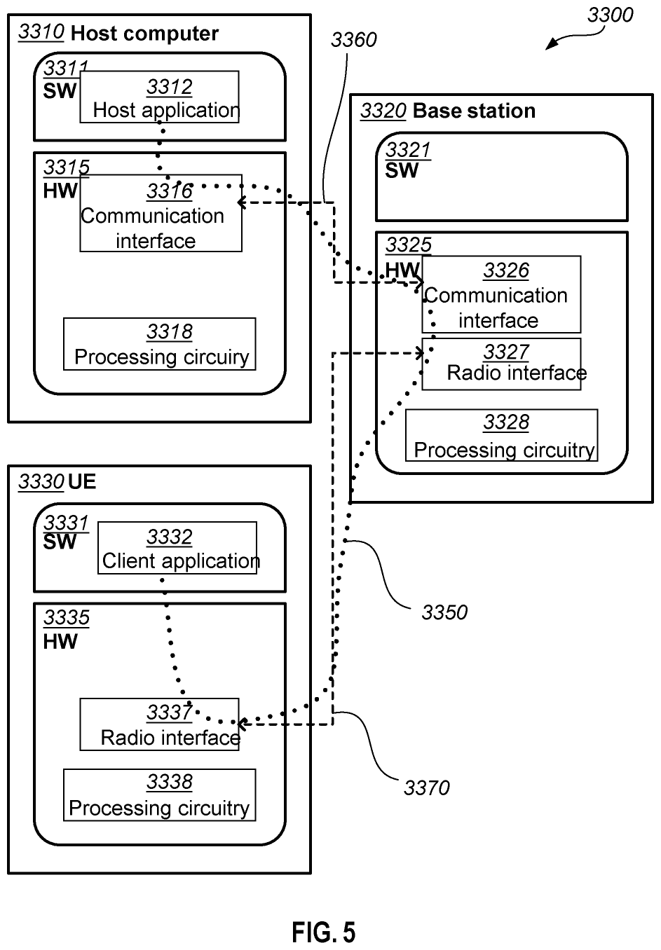

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to setup and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 5) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to setup and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

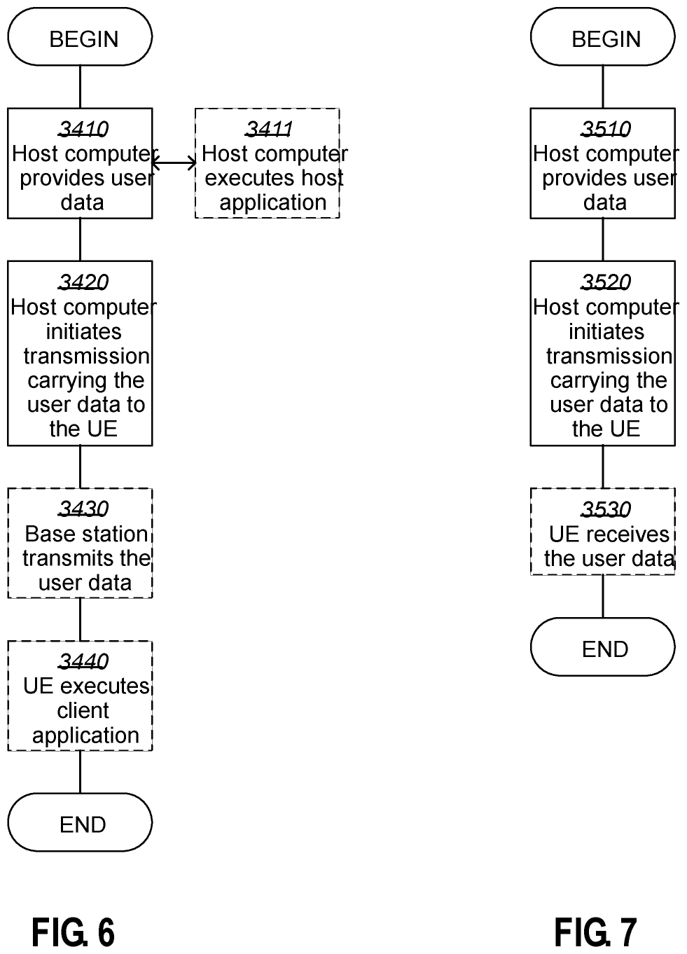

FIG. 6 is a flowchart illustrating a method implemented in a communication system, in accordance with one embodiment. The communication system includes a host computer, a base station such as a AP STA, and a UE such as a Non-AP STA which may be those described with reference to FIG. 4 and FIG. 5. For simplicity of the present disclosure, only drawing references to FIG. 6 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 7 is a flowchart illustrating a method implemented in a communication system, in accordance with one embodiment. The communication system includes a host computer, a base station such as a AP STA, and a UE such as a Non-AP STA which may be those described with reference to FIG. 4 and FIG. 5. For simplicity of the present disclosure, only drawing references to FIG. 7 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

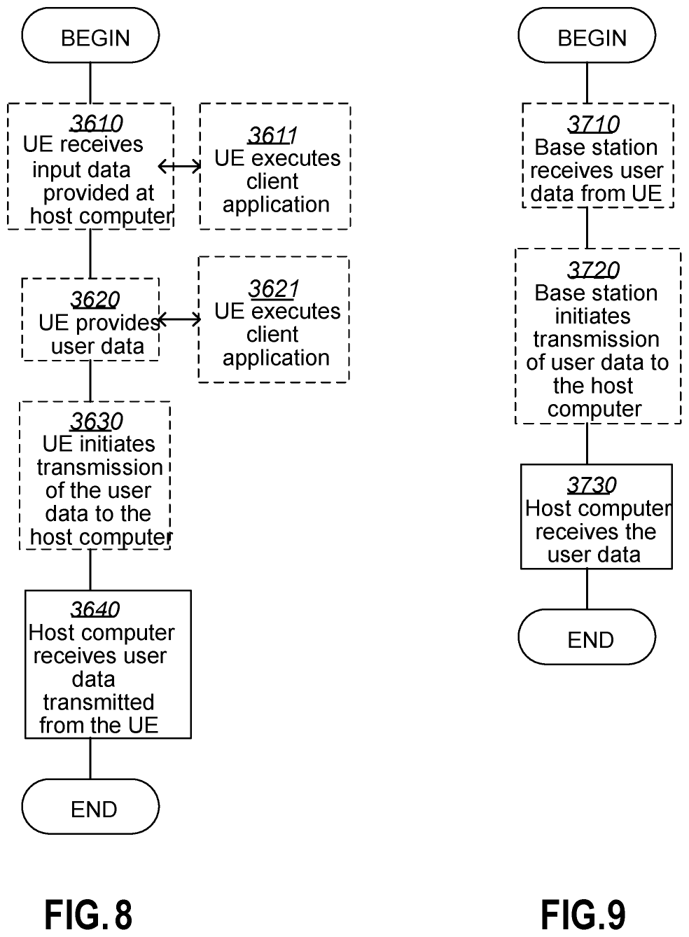

FIG. 8 is a flowchart illustrating a method implemented in a communication system, in accordance with one embodiment. The communication system includes a host computer, a base station such as a AP STA, and a UE such as a Non-AP STA which may be those described with reference to FIG. 4 and FIG. 5. For simplicity of the present disclosure, only drawing references to FIG. 8 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 9 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a radio device for handling data transmissions in a wireless communications network, the method comprising:
determining one or more first transmission parameters for a first part of an application data unit to be transmitted and one or more second transmission parameters for one or more second parts of the application data unit to be transmitted; and
transmitting the application data unit using the one or more first transmission parameters for transmitting the first part of the application data unit and the one or more second transmission parameters for transmitting the one or more second parts of the application data unit.

2. The method according to claim 1, further comprising:
determining boundaries of the application data unit to be transmitted, which boundaries comprise the start and the end of the application data unit; and
wherein determining the one or more first transmission parameters and the one or more second transmission parameters further comprise determining the first part and the one or more second parts of the application data unit, taking the determined boundaries into account.

3. The method according to claim 1, wherein a value of at least one of the one or more first parameters is different from the value of a corresponding parameter of the one or more second transmission parameters.

4. The method according to claim 1, wherein a transmission parameter is any one or more out of:
a modulation and coding scheme, MCS; and
a retransmission policy.

5. The method according to claim 1, wherein the first part of the application data unit is transmitted before the one or more second parts of the application data unit.

6. The method according to claim 1, wherein the one or more first transmission parameters and one or more second transmission parameters are determined to maximize a success rate for the transmission of the application data unit.

7. The method according to claim 1, wherein the one or more first transmission parameters and one or more second transmission parameters are determined to minimize that amount of radio resources used for the transmission of the application data unit.

8. The method according to claim 1, wherein the one or more first transmission parameters and one or more second transmission parameters are determined to minimize a transmission delay of the transmission of the application data unit.

9. The method according to claim 1, wherein the one or more first transmission parameters and one or more second transmission parameters are determined to minimize an error rate for the transmission of the application data unit.

10. (canceled)

11. A computer storage medium storing a computer program comprising instructions, which when executed by a processor, cause the processor to:
determine one or more first transmission parameters for a first part of an application data unit to be transmitted and one or more second transmission parameters for one or more second parts of the application data unit to be transmitted; and
transmit the application data unit using the one or more first transmission parameters for transmitting the first part of the application data unit and the one or more second transmission parameters for transmitting the one or more second parts of the application data unit.

12. (canceled)

13. A radio device configured to handle data transmissions in a wireless communications network, the radio device further configured to:
determine one or more first transmission parameters for a first part of an application data unit to be transmitted and one or more second transmission parameters for one or more second parts of the application data unit to be transmitted; and
transmit the application data unit using the one or more first transmission parameters for transmitting the first part of the application data unit and the one or more second transmission parameters for transmitting the one or more second parts of the application data unit.

14. The radio device according to claim 13, wherein the radio device is further configured to:
determine boundaries of the application data unit to be transmitted, which boundaries are adapted to comprise the start and the end of the application data unit; and
determine the one or more first transmission parameters and the one or more second transmission parameters by further being configured to determine the first part and the one or more second parts of the application data unit, taking the determined boundaries into account.

15. The radio device according to claim 13, wherein a value of at least one of the one or more first parameters is adapted to be different from the value of a corresponding parameter of the one or more second transmission parameters.

16. The radio device according to claim 13, wherein a transmission parameter is adapted to be any one or more out of:
a modulation and coding scheme, MCS; and
a retransmission policy.

17. The radio device according to claim 13, wherein the first part of the application data unit is adapted to be transmitted before the one or more second parts of the application data unit.

18. The radio device according to claim 13, wherein the one or more first transmission parameters and one or more second transmission parameters are adapted to be determined to maximize a success rate for the transmission of the application data unit.

19. The radio device according to claim 13, wherein the one or more first transmission parameters and one or more second transmission parameters are adapted to be determined to minimize that amount of radio resources used for the transmission of the application data unit.

20. The radio device according to claim 13, wherein the one or more first transmission parameters and one or more second transmission parameters are adapted to be determined to minimize a transmission delay of the transmission of the application data unit.

21. The radio device according to claim 13, wherein the one or more first transmission parameters and one or more second transmission parameters are adapted to be determined to minimize an error rate for the transmission of the application data unit.

22. The radio device according to claim 13, wherein the radio device is adapted to be any one out of:
a radio network node; or
a User Equipment, UE.
